(19) United States
(12) Patent Application Publication
(10) Pub. No.: US 2025/0334399 A1
(43) Pub. Date: Oct. 30, 2025

(54) Three-Dimensional Dynamic Interferometric Surface Probe

(71) Applicant: D4D Technologies, LLC, Richardson, TX (US)

(72) Inventor: Mohammad Youssof, Allen, TX (US)

(21) Appl. No.: 18/651,203

(22) Filed: Apr. 30, 2024

(51) Int. Cl. G01B 11/30

(52) U.S. Cl. CPC G01B 11/303

(57) ABSTRACT

Systems and methods for generating high-resolution three-dimensional topographical measurements using differential interferometry are disclosed. Multiple interferometers transmit coherent light, which may comprise diffraction fringes, along similar optical paths to physical target and reference objects to be measured. The target object may vary in scale, such as a tooth at a smaller scale or a geographic region at a larger scale. An imaging device captures interferograms containing phase information from the target object, the reference object, and various noise sources such as thermal variations, air turbulence, micro-scatterers, external light sources, mechanical vibrations, and electromagnetic interference. Common-mode noise from the interferograms is effectively canceled out, yielding substantially noise-free phase information from the target object that can be processed to produce a three-dimensional target object model. The disclosure is of particular utility with portable instruments since the typical noise sources limiting the use of interferometry outside a controlled environment are largely eliminated.

### TECHNICAL FIELD

This disclosure relates generally to optical scanning devices, and more specifically to high-resolution three-dimensional topographical measurements of a target object using differential interferometry.

### BACKGROUND

Interferometry is a known method for acquiring information about the shape of a surface of interest without mechanically contacting that surface. A coherent light source typically illuminates both a target object and a reference object (which is often a merely highly polished flat surface), and the reflected light waves from each object are combined to cause interference patterns. These patterns may be captured by an imaging device as a hologram.

The resulting interference pattern contains phase information regarding the three-dimensional light field, and can be processed to determine the three-dimensional shape of the target object with considerable precision. Shape data may be useful to determine if an object meets specified manufacturing tolerances, for example. In other uses, the recordation of a target object's shape may be a first step for subsequent actions, including cartography or manufacturing of prosthetic devices.

Unfortunately, the captured phase information also includes undesirable noise components that can confound such a shape determination. Phase noise can be the result of many different physical phenomena, including for example, thermal variations, air turbulence in the atmosphere between the interferometer and the target object, micro-scatterers, external light sources, mechanical vibrations, and electromagnetic interference.

Due to the inherent high sensitivity of a typical interferometer, the noise components in the phase data can be difficult to isolate from target object data components. Interferometry is therefore of limited utility, often requiring cumbersome and highly-calibrated equipment in special-purpose controlled laboratory settings designed to minimize phase noise sources to produce useful results. An improved approach to handling such phase noise would help make interferometry much more widely applicable.

### BRIEF SUMMARY

In some aspects, the techniques described herein relate to an apparatus including: a first interferometer; a second interferometer; an illuminator that provides coherent light to the first interferometer and to the second interferometer; and an imager that simultaneously captures a first set of interferograms of a target object and a reference object from the first interferometer and a second set of interferograms of the target object and the reference object from the second interferometer, wherein the first set of interferograms and the second set of interferograms each encode phase information from the target object, the reference object, and noise sources, and wherein encoded noise data from the first set of interferograms and the second set of interferograms is differentially minimized to yield substantially noise-free phase information from the target object.

In some aspects, the techniques described herein relate to an apparatus, wherein the first interferometer and the second interferometer are optically identical.

In some aspects, the techniques described herein relate to an apparatus, wherein the first interferometer and the second interferometer share a common reference object.

In some aspects, the techniques described herein relate to an apparatus, wherein the first interferometer and the second interferometer are positioned at substantially equal distances from the target object.

In some aspects, the techniques described herein relate to an apparatus, wherein the first interferometer and the second interferometer are symmetrically positioned around the imager.

In some aspects, the techniques described herein relate to an apparatus, wherein the coherent light includes diffraction fringes.

In some aspects, the techniques described herein relate to an apparatus, wherein the coherent light emitted by at least one of the first interferometer and the second interferometer passes through a compensator optical element.

In some aspects, the techniques described herein relate to an apparatus, wherein the coherent light has a wavelength selected to provide a specific amount of intrinsic scattering within the target object.

In some aspects, the techniques described herein relate to an apparatus, wherein the noise sources include at least one of thermal variations, air turbulence, micro-scatterers, external light sources, mechanical vibrations, and electromagnetic interference.

In some aspects, the techniques described herein relate to an apparatus, wherein the target object includes one of a region of dental anatomy and a geographic region.

In some aspects, the techniques described herein relate to a method, including: producing a first set of interferograms of a target object and a reference object using a first interferometer; simultaneously producing a second set of interferograms of the target object and the reference object using a second interferometer, wherein the first set of interferograms and the second set of interferograms each encode phase information from the target object, the reference object, and noise sources; and differentially minimizing encoded noise data from the first set of interferograms and from the second set of interferograms to yield substantially noise-free phase information from the target object.

In some aspects, the techniques described herein relate to a method, wherein the first interferometer and the second interferometer are optically identical.

In some aspects, the techniques described herein relate to a method, wherein the first interferometer and the second interferometer share a common reference object.

In some aspects, the techniques described herein relate to a method, wherein the first interferometer and the second interferometer are positioned at substantially equal distances from the target object.

In some aspects, the techniques described herein relate to a method, wherein the first interferometer and the second interferometer are symmetrically positioned around an imager that captures the first set of interferograms and the second set of interferograms.

In some aspects, the techniques described herein relate to a method, wherein coherent light used by the first interferometer and the second interferometer includes diffraction fringes.

In some aspects, the techniques described herein relate to a method, wherein coherent light emitted by at least one of the first interferometer and the second interferometer passes through a compensator optical element.

In some aspects, the techniques described herein relate to a method, wherein coherent light used by the first interferometer and the second interferometer has a wavelength selected to provide a specific amount of intrinsic scattering within the target object.

In some aspects, the techniques described herein relate to a method, wherein the noise sources include at least one of thermal variations, air turbulence, micro-scatterers, external light sources, mechanical vibrations, and electromagnetic interference.

In some aspects, the techniques described herein relate to a method, wherein the target object includes one of a region of dental anatomy and a geographic region.

In some aspects, the techniques described herein relate to a system, including: means for producing a first set of interferograms of a target object and a reference object using a first interferometer; means for simultaneously producing a second set of interferograms of the target object and the reference object using a second interferometer, wherein the first set of interferograms and the second set of interferograms each encode phase information from the target object, the reference object, and noise sources; and means for differentially minimizing encoded noise data from the first set of interferograms and from the second set of interferograms to yield substantially noise-free phase information from the target object.

In some aspects, the techniques described herein relate to a computer program product including a non-transitory computer-readable medium with computer-executable instructions tangibly embodied thereon that, when executed by a processor, perform operations including: producing a first set of interferograms of a target object and a reference object using a first interferometer; simultaneously producing a second set of interferograms of the target object and the reference object using a second interferometer, wherein the first set of interferograms and the second set of interferograms each encode phase information from the target object, the reference object, and noise sources; and differentially minimizing encoded noise data from the first set of interferograms and from the second set of interferograms to yield substantially noise-free phase information from the target object.

The foregoing description has outlined some of the more pertinent features of the subject matter. These features should be construed to be merely illustrative.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document. For a more complete understanding of the disclosed subject matter and the advantages thereof, reference is now made to the following descriptions taken in conjunction with the accompanying drawings, in which:

FIG. 1 depicts a basic view of an embodiment of a conventional holographic imaging system;

FIG. 2 depicts the known structure of a tooth, which may be a typical target object according to this disclosure;

FIG. 3 depicts an illuminator for a differential interferometer apparatus according to this disclosure;

FIG. 4 depicts a differential interferometer apparatus according to this disclosure;

FIG. 5 depicts the differential interferometer apparatus as employed to also obtain data regarding a physical target object according to this disclosure;

FIG. 6 depicts a conceptual diagram of a differential interferometer obtaining data from a physical target object in direct contact with a reference object for testing purposes according to this disclosure;

FIG. 7 depicts a conceptual diagram of a differential interferometer obtaining data from a physical target object in a realistic three-dimensional setting according to this disclosure;

FIG. 8 depicts a flowchart describing the operation of a differential interferometer system in which the techniques of this disclosure may be implemented;

FIG. 9 depicts observed slowness versus displacement according to this disclosure;

FIG. 10 depicts observed slowness versus phase according to this disclosure;

FIG. 11 depicts equations describing differences in phase data between two scanned points for both reference and target objects according to this disclosure;

FIG. 12 depicts a computing component that may carry out the functionality according to this disclosure; and

FIG. 13 depicts equations describing a wave formulation of phase differences according to this disclosure.

### DETAILED DESCRIPTION OF THE EMBODIMENTS

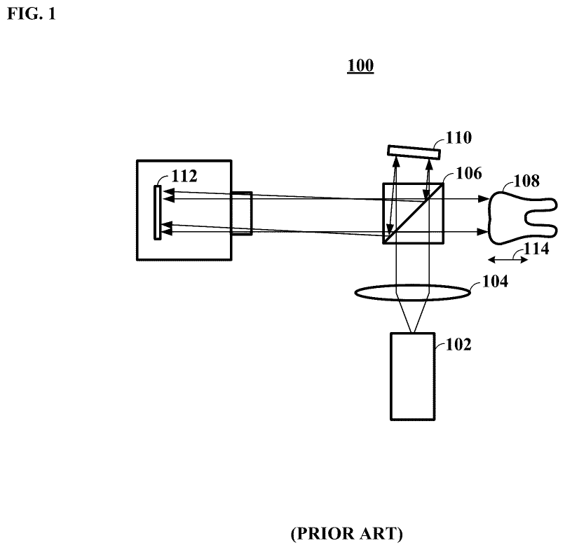

FIG. 1 depicts a basic view of an embodiment of a conventional holographic imaging system 100. Radiation source 102 emits coherent radiation, which for purposes of initial simplified explanation may be assumed to comprise only a single wavelength of light. Collimating lens 104 delivers the light into a beamsplitter 106, illustrated here as a cube type, although other types of beamsplitters are known in the art.

Beamsplitter 106 reflects some of the incoming radiation toward a physical object 108, shown here as an exemplary but non-limiting tooth, being imaged. Beamsplitter 106 also transmits some of the incoming radiation toward a mirror 110, which is typically slightly tilted. Radiation reflecting from mirror 110 forms a reference beam that is partly reflected toward an imaging sensor 112. Historically, film cameras were used as imaging sensors 112, but digital devices such as high resolution CMOS cameras or CCDs are increasingly used today. Some of the radiation reflecting from physical object 108 also travels through beamsplitter 106 to arrive at imaging sensor 112.

The radiation that arrives at imaging sensor 112 thus comprises radiation from an object beam that was reflected from physical object 108 and a reference beam that was reflected from tilted mirror 110. Imaging sensor 112 records the intensity of the incoming radiation, which varies according to the superposition of the arriving wavefronts to form an interference pattern. The slight tilting of mirror 110 helps ensure a discernible phase difference exists between different wavefronts arriving via similar paths. The captured pattern of intensities encodes information regarding the three-dimensional nature of physical object 108, as well as information from various noise sources.

A depth imaging range 114 of the physical object may be determined by the wavelength of radiation used and a level of tolerable noise. The end result is that precise depth data may be recorded by a conventional holographic system, but only for a depth range comparable to about half of the wavelength of radiation used. For macroscopic objects illuminated by visible light, this depth range may be insufficient for some intended uses, such as producing a precise three-dimensional model of a physical object that includes more than just a very thin layer of its upper surface.

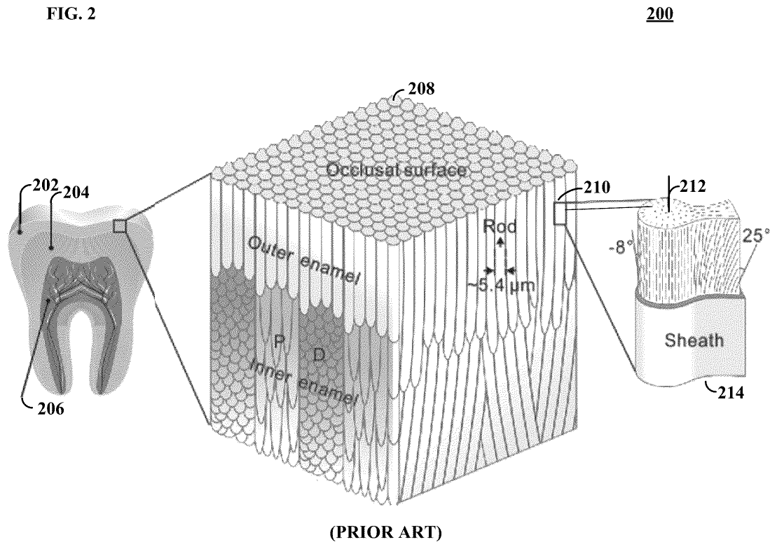

FIG. 2 depicts the known structure of a tooth 200, which may be an exemplary but non-limiting target object, like target object 108 of FIG. 1, according to this disclosure. Tooth 200 generally comprises an outer layer of enamel 202 covering and in places somewhat intermixing with an underlying layer of more porous dentin 204, as shown in the enlarged central portion of the figure. A pulp chamber 206 is the innermost layer of tooth 200, and contains blood vessels, nerves, and other living cells, which are all protected by enamel 202 and dentin 204.

Enamel 202 is the hardest substance in the human body and primarily comprises hydroxyapatite, a crystallized form of calcium phosphate, along with interlinking proteins. However, outermost occlusal surface 208 of the tooth does not comprise a merely undifferentiated or amorphous mass of hydroxyapatite. Instead, occlusal surface 208 comprises a plurality of crystalline rods 210 that are chemically and mechanically interconnected to each other and to underlying dentin 204, forming a composite structure.

Each rod 210 is approximately 5.4 microns in size on average, as illustrated, and comprises a bundle of thousands of individual hydroxyapatite fibers 212 that are each typically approximately 35 nanometers in diameter. Fibers 212 in each rod 210 are roughly parallel in orientation, but some fibers 212 may vary from parallel alignment, typically by eight to twenty-five degrees in various different directions as shown. Fibers 212 are encased within a sheath 214 that helps interconnect rods 210 to each other, again in a roughly parallel but somewhat cross-linked composite arrangement.

The structure of tooth 200 provides mechanical strength so that one tooth 200 can be compressed against another with considerable force during chewing. The structure of tooth 200 also has some interesting optical properties due to its multi-layered composite nature. The wavelength of the light employed may be selected to provide a specific amount of intrinsic scattering within tooth 200 or other target object.

For example, enamel 202 is highly reflective in the blue visual region of the electromagnetic spectrum, but can transmit longer wavelengths of light, e.g., red and infrared, much more readily. Enamel 202 is thus translucent to some extent to a range of wavelengths. Green light of approximately 532 nm can thus both reflect well off occlusal surface 208 and also penetrate inward to the inner boundary between outer enamel layer 202 and underlying dentin layer 204.

An optical examination of tooth 200 may thus detect light reflected directly from the occlusal surface 208 as well as light that is transmitted through at least a portion of enamel layer 202 to dentin 204 and then reflected outward again. Generation of three-dimensional models of the exterior surfaces of teeth 200 may thus rely primarily on the directly reflected light, but the transmitted light may also be significant for various exploratory purposes. The interferometric distinction of directly reflected light and the light reflected from interior portions of tooth 200 from phase noise sources is therefore of particular utility. Other biological tissues may also be amenable to such scanning for medical purposes, such as detecting tumors or other structures under a patient's skin.

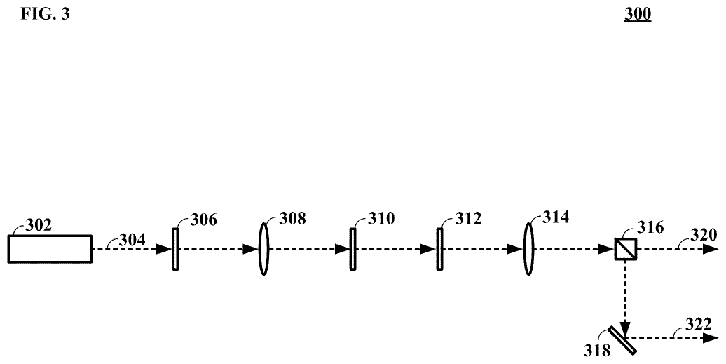

FIG. 3 depicts an illuminator 300 for a differential interferometer apparatus according to this disclosure. Unlike the single conventional interferometer 100 previously described for FIG. 1, the apparatus to be described actually comprises twin interferometers. In the best mode for implementing the disclosure, each interferometer is optically identical.

Coherent light source 302 is typically a single-mode laser that emits substantially monochromatic light in a beam of very narrow width. For example, a Coherent® brand 200 milliwatt laser emitting green light of 532 nm wavelength is a typical laser that may be applicable to this disclosure. Other lasers may also be employed as may be known in the art.

Illuminator 300 further comprises additional optical components to produce a pair of highly focused beams with a stable phase relationship. Output beam 304 may for example propagate through a pinhole aperture 306 that excludes most off-axis light. A typical aperture 306 may be only 100 micrometers in diameter, for example. Next, the pinhole-limited output beam may further pass through a focusing lens 308, e.g., a 50 mm lens. The focused output beam may then pass through at least one neutral density filter 310, to limit its intensity, and then through an iris 312. The filtered output beam may then pass through a second focusing lens 314, e.g., a 200 mm lens, and possibly further focusing lenses.

Beamsplitter 316 may then split the output beam into two components, 318 and 320. Component 320 may be made to propagate in parallel with component 318 via an adjustable mirror 318. Output beam components 318 and 320 are thus as close to ideal coherent single-point emitters as is convenient with ordinary optical components. Each exemplary beam component is also referred to as a light source for purposes of this description.

Additional optical components, not shown, may generate diffraction fringes (i.e., interference fringes) from components 318 and 320, for use as light sources for the twin interferometer to be described. Diffraction fringes may result from a diffraction grating, for example, or a beamsplitter and a tilted mirror, and have the advantage of infinite depth of field. Complex objects may be lit without the need for source focus when using diffraction fringes.

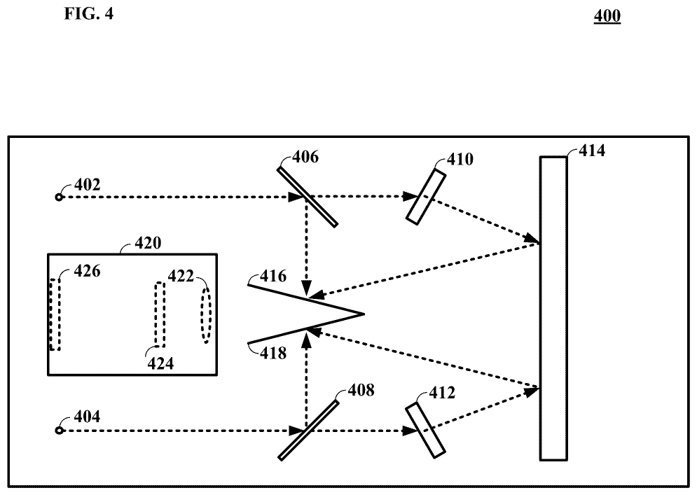

FIG. 4 depicts a differential interferometer apparatus 400 according to this disclosure. Conventional interferometers are very sensitive to a variety of noise sources, which limits their utility in uncontrolled environments. Differential interferometer 400 disclosed herein overcomes this limitation with two preferably identical interferometers by making measurements of a target object with each interferometer. The disclosure methodology then simultaneously minimizes errors from unmodeled perturbations in the measured data due to all of the common noise sources in the data measured during imaging. Note that this diagram is somewhat conceptual and that the actual dimensions of physical implementations will vary.

Point light sources 402 and 404 provide coherent light to beamsplitting mirrors 406 and 408, respectively. These sources preferably provide diffraction fringes as noted above. A portion of the light coming from beamsplitting mirrors 406 and 408 is transmitted to compensating elements 410 and 412, respectively, which direct the light toward a reference object 414. Reference object 414 is preferably a highly polished transparent optical flat that is a common object for each of the interferometers, so that the light from either beam that reflects from reference object 414 will be as identical as possible in terms of the phase data encoded.

Light reflected from reference object 414 is transferred to partial mirrors 416 and 418, where it is combined with light reflected directly from beamsplitting mirrors 406 and 408, respectively. The resulting interference patterns are then recorded by an imaging device 420, comprising a lens 422, an optional compensating element 424, and imager 426. These interference patterns are useful for testing the optical system alignment but are not generally used for scanning of objects.

Imager 426 may comprise a charge-coupled device (CCD) based camera that can record light intensities at a large number of receptor elements, as may be known in the art. For example, one imager 426 used in an embodiment has a resolution of 4096 by 3000 pixels, and a pixel size of 3.45 micrometers. Imagers 426 may be high speed devices capable of capturing a significant number of images in a short time. Data from these multiple images may be used to average out some noise data through image stacking.

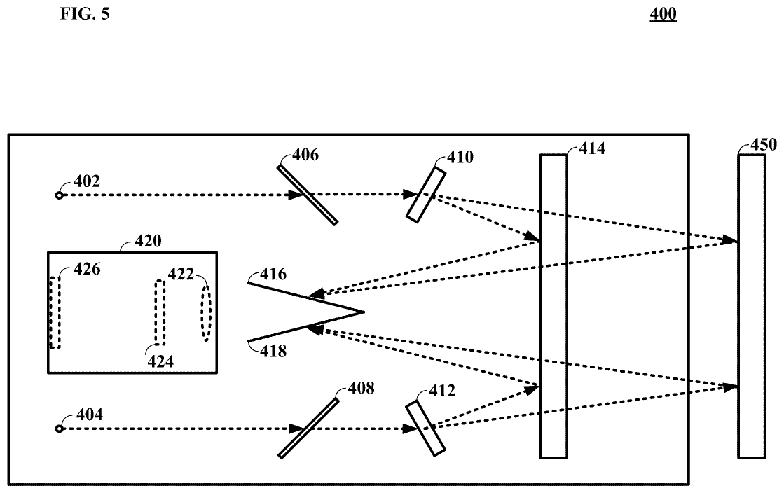

FIG. 5 depicts the differential interferometer apparatus 400 as employed to also obtain data regarding a physical target object 450 according to this disclosure. This figure modifies FIG. 4 by adding target object 450, which is also illuminated by each of the two interferometers in a similar manner as how reference object 414 is illuminated. Each of the interferometers of differential interferometer apparatus 400 is preferably positioned at substantially equal distances from target object 450, and the two interferometers are preferably symmetrically positioned around imager 426.

Point light sources 402 and 404 provide coherent light to beamsplitting mirrors like 406 and 408, respectively. The portion of the light propagating directly from mirrors 406 and 408 to mirrors 416 and 418, used for alignment testing, is omitted in this diagram for clarity. A portion of the light coming from the beamsplitting mirrors may be transmitted to compensating elements like 410 and 412, respectively, which may direct the light toward target object 450. Target object 450 may for example comprise a portion of a dental patient's anatomy, such as one or more teeth as previously described. Imager 426 captures interferograms from each interferometer; each such interferogram results from the interference of light reflecting from each interferometer's reference object 414 and target object 450.

The interference patterns recorded by imager 426 for each interferometer thus encode phase data from three sources: the topographic variation of reference object 414, the topographic variation of target object 450, and noise sources. If the point pairs on an object being illuminated are close together compared to the distance between the light source and imager 426, then the beam paths between the source and imager 426 are very similar. If reference object 414 is a highly polished transparent optical flat, the reflected beams illuminating reference object 414 will encode relatively little difference in phase data.

The noise sources may all be modeled together as a “slowness field” denoting a decrease in the propagation speed of light during a measurement due to one or more anomalies in the light's propagation path. As mentioned, such decreases could be due to thermal variations, air turbulence in the atmosphere between an interferometer and reference object 414 and/or target object 450, micro-scatterers, external light sources, mechanical vibrations, and electromagnetic interference. Any anomaly that slows the propagation of light will generally tend to increase the phase accumulated during propagation from the illuminator to imager 426. If the light from each interferometer follows similar ray paths from sources to imager 426, the phase data encoded from the slowness field will be similar for each path. The result is that the difference in phase between the similar paths will be reduced, ideally to zero.

Thus, with two preferably identical interferometers, each capturing phase data from a target object, a reference object, and a slowness field, there are essentially six unknowns to be resolved. However, if the phase data from each reference object 414 is similar, which is the case if reference object 414 is common for each interferometer as shown and is a highly-polished transparent optical flat, an estimate that the phase data difference from reference object 414 is zero is a good one. Likewise, if the phase data from the slowness field for each interferometer is similar, an estimate that the phase difference from the slowness fields is zero is a good one. Thus, the difference in phase between any two interferometrically observed points on a target object at any instant can be attributed to the spatial height offset between the point pairs being imaged, if other phase differences can be minimized, ideally to zero.

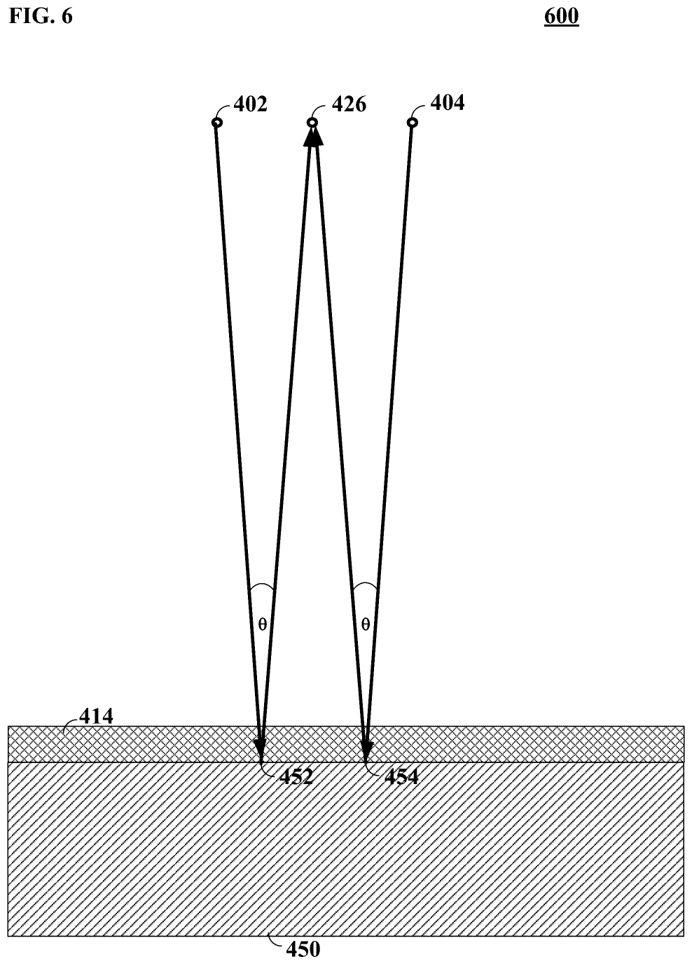

FIG. 6 depicts a conceptual diagram of a differential interferometer 600 obtaining data from physical target object 450 in direct contact with reference object 414 for testing purposes according to this disclosure. This arrangement features two point light sources 402 and 404, each illuminating a first target point 452 and a second target point 454, where the target points are closely spaced. In this test situation, reference object 414 comprises a highly polished transparent optical flat that is in direct contact with target object 450 which is also a highly polished optical flat. (Note that in regular measurement scenarios, target object 450 may be partially translucent in some instances, such as in tooth 200 where secondary reflections may be of significant interest.)

The interface plane between reference object 414 and target object 450 is thus the flat surface being optically probed. Light from sources 402 and 404 propagates through reference object 414 and reflects off the interface plane and back to imager 426. The angle between imager 426 and each light source is small, approximately four degrees in this example.

In this example, the difference in the phase measured between the reflections from the interface will be very nearly zero, as there is very little phase difference due to any topographic differences. Therefore, virtually all of the phase differences observed by imager 426 are due to the slowness field. In a controlled environment with virtually no anomalies to cause changes in the propagation speed of light, there will be very little phase difference data measured, so this an ideal test setup.

However, this test setup is also an ideal arrangement for studying the slowness field per se, i.e., the anomalies causing observed phase noise. This investigational objective may be of significant utility in itself, not just in examining how well controlled the measurement environment may be. For example, the anomalies could be of significant interest for medical purposes, e.g., they could comprise tumors under a patient's skin or gum tissue, or any other objects in the area between the light sources and the target objects being scanned.

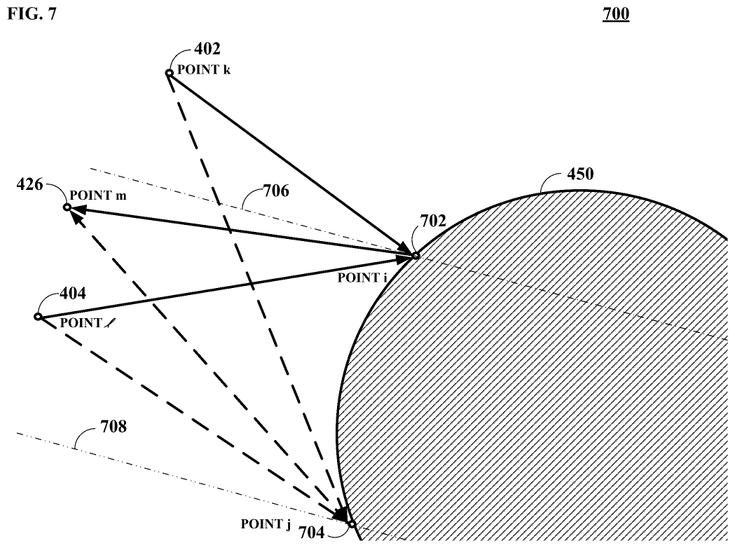

FIG. 7 depicts a conceptual diagram of a differential interferometer 700 obtaining data from physical target object 450 in a realistic three-dimensional setting according to this disclosure. The discussion of this figure describes data from physical target object 450 but similar data is gathered simultaneously from reference object 414 (not shown).

For dental scanning, the interference patterns from light sources 402 and 404 may effectively cover an area of approximately 1.46 cm², in one embodiment. However, the disclosure is not limited to dental scanning, but may instead be applied to physical target objects 450 of different sizes. For example, intermediate scale scans may be made of a medical patient's skin to identify anomalies over an area of tens to hundreds of cm². Further, larger scale scans may be made of a geographical area to identify anomalies over an area of perhaps several m² to several km² or more.

Light source 402 (termed “Point k” for later reference in equations) and light source 404 (termed “Point l”) transmit light to scanned points 702 (termed “Point i”, solid rays in the figure) and point 704 (termed “Point j”, dashed rays in the figure) on physical target object 450. Rays originating from the sources have the same, preferably fixed, frequency, and typically the same intensity. Two bright fringes, fringe 706 and fringe 708 are also indicated.

Differences in the propagation distance for the rays impinging on target object 450 correspond to differences in topology of target object 450 alone in an ideal case, but also in differences in the slowness field in a real case. Light source 402 preferably emits wavefronts (in the ray approximation) in the form of diffraction fringes that shape different lines or interference patterns, such as fringe 708. Point j 704 is sampled, in this example, at this fringe. Each ray originates with an in-going phase Φ and reflects with an outgoing phase shift of 2π+ΔΦ. The quantity ΔΦ is the total difference in phase shift accumulated over each distance dl or a measure of phase dΦ within the slowness field s(l) or s(Φ) during propagation. Note that scattering is also a relevant physical process that adds an unknown quantity of phase depending on the penetration of target object 450. That is, the phase data includes the travel of an incident ray some distance into target object 450 and the reflection of that ray back out again.

The observed total phase shift of a ray originating from light source 402 (“k”), reflected at a single point and ultimately received at imager 426 (“m”), expressed using a ray theory, may therefore be written as a path integral along the ray:

$$Δ {Φ}_{m}^{k} = [ {\int }_{k}^{m} {ω}_{t} {s}^{2} dl ] - [ {Φ}_{t}^{k} ] \qquad ( 1 )$$

where Φ^{k}ₜ is the true controlled phase originated at point k, ωₜ is the known frequency of light used (i.e., 2π fₜ), s is the slowness field for the medium between light source 402 and imager 426, and dl is an element of path length. This equation may also be written as:

$$Δ {Φ}_{m}^{k} = - [ {Φ}_{t}^{k} ] + 2 π {f}_{t} [ {\int }_{k}^{m} {ω}_{t} {s}^{2} ( Φ ) d ( Φ ) ] \qquad ( 2 )$$

by expressing the slowness field as a function of phase instead of displacement length. Similar expressions can be written for light from source 404 for the observed total phase shift of a ray originating from light source 404 (“l”) reflected at a single nearby point and ultimately received at imager 426 (“m”). Likewise, similar expressions can be written for light reflected from reference object 414 (not shown). Although here the expressions are written in terms of ray theory, equation (1) can be extended into a wave approximation using Born's perturbation theory. See Appendix 1.

Both points 702 and 702 are measured essentially simultaneously when imager 426 is at specific position m because both points are sufficiently proximate. Both rays traverse nearly identical paths through the slowness field so will undergo practically identical phase shifting as a result. Likewise, in a preferred embodiment both rays that reflect from a common reference object 414 will have practically identical reference phase values. The advantage of the dual interferometer design is thus that these systematic similarities in phase values due to these causes may simplify the determination of phase due to target object 450 topography.

The observed total phase shifts ΔΦ^{k}ₘ and ΔΦ^{l}ₘ will thus be virtually identical unless there is a topography difference in the observed object that is comparable with the spatial separation between the points. The difference in physical surface irregularity between these two points is related to the difference between these two measurements, termed δΔΦ^{ij}ₘ. Thus, the phase information may provide roughness level surface information.

The general relationship between phase difference and a given point in space is nonlinear. Therefore, a truncated Taylor series expansion can be used to linearize the relationship. The result is that phase difference residuals r, for a point i having x, y, and z spatial coordinates are linearly related to some perturbations Δm, such that:

$$\frac{\partial {ϕ}_{m}^{k}}{\partial m} Δ {m}^{i} = {r}_{m}^{k} . \qquad ( 3 )$$

Likewise for point j,

$$\frac{\partial {ϕ}_{m}^{l}}{\partial m} Δ {m}^{j} = {r}_{m}^{l} .$$

Here, residual

$${r}_{m}^{k} = {Φ}_{i}^{k} - {Φ}_{m}^{i} = Δ {Φ}_{m}^{k} and$$

$${r}_{m}^{l} = {Φ}_{j}^{l} - {Φ}_{m} = Δ {Φ}_{m}^{l} , where$$

$$Δ {m}^{i} = ( Δ {x}^{i} , Δ {y}^{i} , Δ {z}^{i} , {Δϕ}^{i} ) and Δ {m}^{j} = ( Δ {x}^{j} , Δ {y}^{j} , Δ {z}^{j} , {Δϕ}^{j} ) .$$

Fréchet (1895) suggested an equation for the relative space parameters between two points i and j by taking the difference of equation (2)

$$Δ {Φ}_{m}^{k} = [ {\int }_{k}^{m} {ω}_{t} {s}^{2} dl ] - [ {Φ}_{t}^{k} ]$$

to be applied to a pair of points as:

$$\frac{\partial {ϕ}_{m}^{ij}}{\partial m} Δ {m}^{ij} = δ {r}_{m}^{ij} \qquad ( 4 )$$

where Δm^{ij}=(Δx^{ij}, Δy^{ij}, Δz^{ij}, Δϕ^{ij}) which represents the change in the relative space parameters between the two points, and the partial derivatives

$$\frac{\partial {ϕ}_{m}^{ij}}{\partial m}$$

are the components of the displacement vector of the ray connecting the source/sensor and the centroid (i.e., the point midway between points i and j).

As an additional step to increase the observables,

$$δ {r}_{m}^{ij}$$

(in equation (4) can be made to represent the residual between the observed and calculated (from a reference frame) differential phase difference between the two points to be defined as:

(Φ^{k}ᵢ−Φⁱₘ)−(Φ^{l}ⱼ−Φ^{j}ₘ)=(δΔΦ^{ij}ₘ)^{obs} for the target object, and similarly for the reference object (Φ^{k}_{i′}−Φ^{i′}ₘ)−(Φ^{l}_{j′}−Φ^{j′}ₘ)=(δΔΦ^{ij}ₘ)^{ref}

$$δ {r}_{m}^{ij} = {( {δΔΦ}_{m}^{ij} )}^{obs} - {( {δΔΦ}_{m}^{ij} )}^{ref} = {δΔΦ}_{m}^{ij} \qquad ( 5 )$$

Thus,

for target body 450, and equation (4) is the complete double-difference formula for the differential residuals of total phase differences.

The assumption of a constant slowness vector should be valid for any points that are sufficiently close together. Equations (3) and (4) are related to the δr^{ij}ₘ term, hence

$$\frac{\partial {ϕ}_{m}^{ij}}{\partial m} Δ {m}^{ij} = {δΔΦ}_{m}^{ij} = δ {r}_{m}^{ij} \qquad ( 6 )$$

Equation (2) may be applied in the case of two positions to yield

$${( \frac{\partial {ϕ}_{m}^{ij}}{\partial m} Δ {m}^{ij} )}^{obs} - {( \frac{\partial {ϕ}_{m}^{i j}}{\partial m} Δ {m}^{ij} )}^{ref} = δ {r}_{m}^{ij} \qquad ( 7 )$$

In full, this equation becomes

$${( \frac{\partial {ϕ}_{m}^{ij}}{\partial x} Δ {x}^{ij} + \frac{\partial {ϕ}_{m}^{ij}}{\partial y} Δ {y}^{ij} + \frac{\partial {ϕ}_{m}^{ij}}{\partial z} Δ {z}^{ij} + Δ {ϕ}^{ij} )}^{obs} - {( \frac{\partial {ϕ}_{m}^{ij}}{\partial x} Δ {x}^{ij} + \frac{\partial {ϕ}_{m}^{ij}}{\partial y} Δ {y}^{ij} + \frac{\partial {ϕ}_{m}^{ij}}{\partial z} Δ {z}^{ij} + Δ {ϕ}^{ij} )}^{ref} = δ {r}_{m}^{ij} \qquad ( 8 )$$

The partial derivatives of the phases for points i and j, with respect to their positions (x,y,z) and phase shift Φ, are calculated for the current position of imager 426 where the m^{th} phase differences were measured, and (Δx^{ij}, Δy^{ij}, Δz^{ij}, and Δϕ^{ij}) are the changes required in the space parameters to make the model better fit the data.

Equation (6) may be combined for all point pairs that can be measured considering one sensor position and for all sensor positions to form linear equations of the form

$$WGm = Wd \qquad ( 9 )$$

where G defines a matrix of size M×4N (where M is the number of double-difference observations, and N is the number of observation points containing the partial derivatives with respect to the model parameters, so 4N is the length of the vector m=[Δx, Δy, Δz, ΔΦ]^{T} containing the changes in space and phase parameters to be determined, d is the data vector containing the double-differences data (i.e., equation (4) is a vector of length M), and W is a diagonal matrix to weight each equation. Therefore, matrix G has M rows and 4N columns so (M×4N)×(4N×1)=(M×1). Each row of G represents the partial derivatives of he double-difference observations with respect to the four parameters in m. The mean shift of all points may be constrained during a relocation process to zero by setting

$${\sum }_{i = 1}^{N} Δ {m}_{i} = 0 \qquad ( 10 )$$

for each coordinate direction and origin phase difference, respectively.

Although this description summarizes the phase measurements in terms of single interferograms from each interferometer for simplicity, in actuality each interferometer may generate sets of interferograms for each of many proximate points being scanned on reference object 414 and target object 450. Thus, the first interferometer may generate a first set of interferograms based on images generated from light reflecting from reference object 414 and target object 450. Likewise, the second interferometer may generate a second set of interferograms based on images generated from light reflecting from a nearby point on reference object 414 and from a nearby point on target object 450. Multiple images may be captured and stacked to increase data quality.

Further, each interferometer of the differential interferometer may then be moved, preferably together, to a different position in space relative to target object 450 to scan additional points on target object 450 following the methodology described. The points scanned preferably encompass a relevant portion of target object 450 such that a relevant three-dimensional model of the topology of target object 450 may be generated.

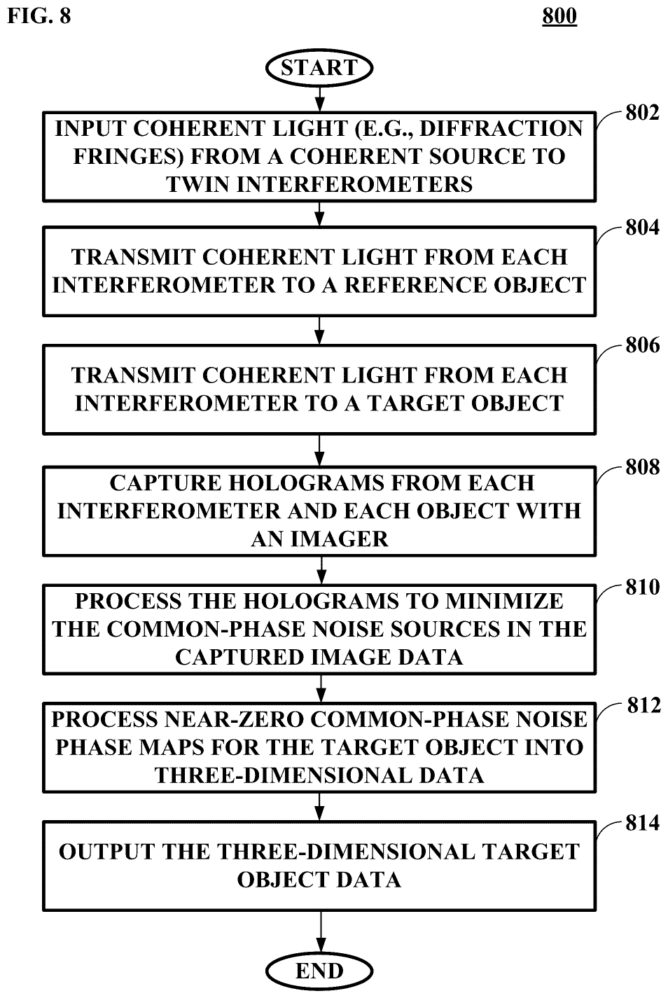

FIG. 8 depicts a flowchart 800 describing the operation of the differential interferometer system in which the techniques of this disclosure may be implemented. One overall objective is to minimize errors from unmodeled slowness field perturbations. At step 802, illuminator 300 provides coherent light (e.g., diffraction fringes) from a coherent source to each of twin interferometers, e.g., light sources 402 and 404. At step 804, the interferometers then illuminate reference object 414. At step 806, the interferometers illuminate target object 450. The different objects are preferably illuminated substantially simultaneously.

At step 808, imager 426 captures holograms (i.e., interferograms) from each of the two interferometers from each object. That is, the first interferometer captures interferograms based on light from reference object 414 and target object 450, and the second interferometer captures interferograms based on light from a nearby point on reference object 414 and from a nearby point on target object 450. At step 810, data from the holograms is processed to minimize the common-phase noise sources in the captured image data, as described above. At step 812, the phase maps for target object 450, which now have nearly zero common-phase noise, are processed into three-dimensional data, as is generally known in the art of three-dimensional scanning. At step 814, the three-dimensional data describing the topography of target object 450 are output, such as for use in designing a prosthetic device for a dental patient or producing a three-dimensional rendering of a geographic region.

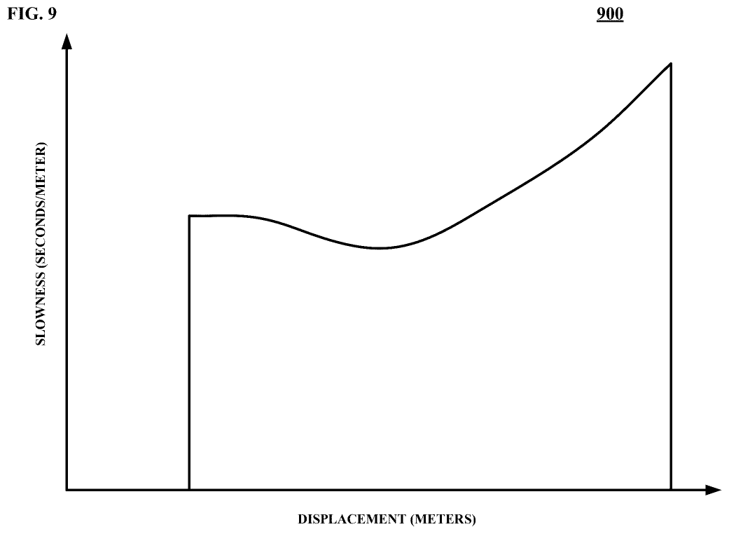

FIG. 9 depicts observed slowness 900 versus displacement according to this disclosure. Slowness is described in terms of the additional propagation time (or additional accumulated phase) due to noise sources that alter the light propagation, with units of seconds per meter. Displacement refers to the distance from the interferometers to target object 450. The accumulated phase shift thus is the area under the curve.

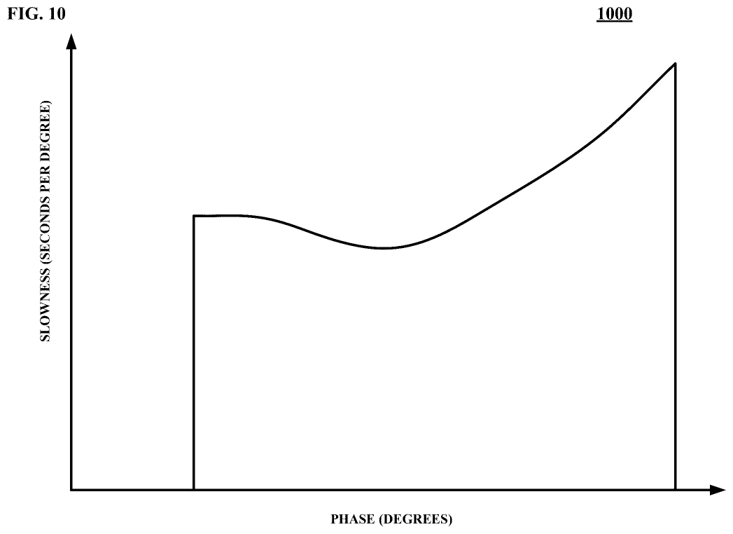

FIG. 10 depicts observed slowness 1000 versus phase according to this disclosure. Slowness is described in terms of the additional propagation phase due to noise sources, with units of seconds per meter. However, since the frequency of the propagating light is known, slowness may also be expressed in terms of seconds per degree of phase. The accumulated phase shift is thus again the area under the curve.

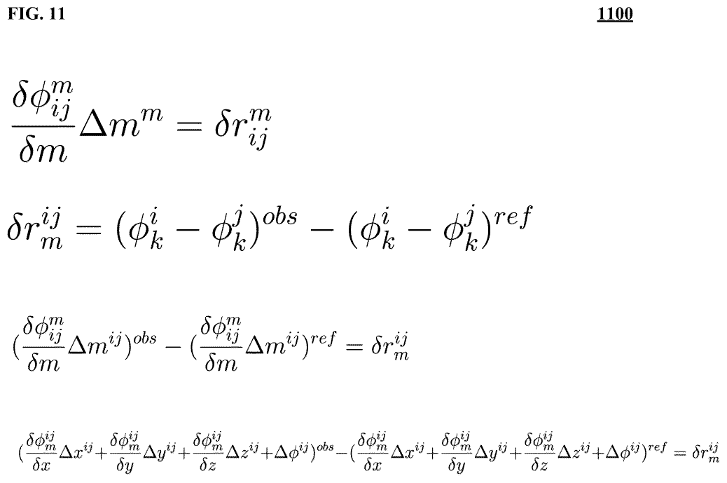

FIG. 11 depicts equations 1100 describing differences in phase data between two scanned points for both reference and target objects according to this disclosure. These equations are described in the discussion of FIG. 7 and are presented here merely for clarity.

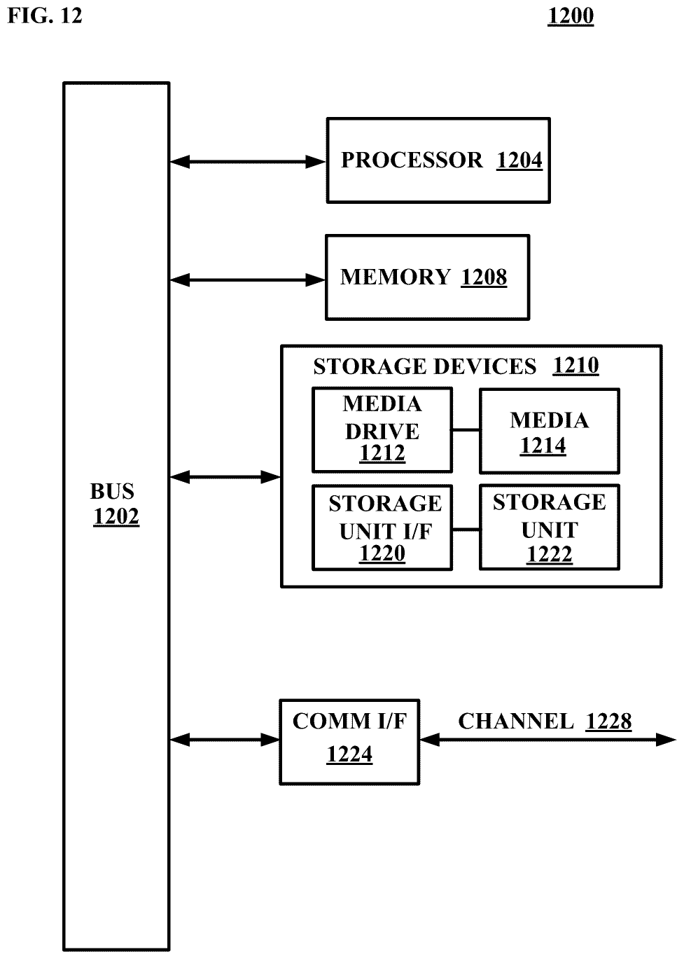

The data encoded on the captured interference patterns may determine spatial coordinates of points on a three-dimensional surface of physical target object 450. The surface coordinates may produce a three-dimensional representation of target object 450, such as for manufacturing a dental appliance or other purposes. Computations for processing the data encoded on the interference pattern may be implemented in a computer program, as a set of program instructions, executable in one or more processors.

Where components or components of the technology are implemented in whole or in part using software, in one embodiment, these software elements can be implemented to operate with a computing or processing component capable of carrying out the functionality described with respect thereto. One such example computing component is shown in FIG. 12. Various embodiments are described in terms of this example computing component 1200. After reading this description, it will become apparent to a person skilled in the relevant art how to implement the technology using other computing components or architectures.

FIG. 12 shows a computing component 1200 that may carry out the functionality described herein, according to an embodiment. Computing component 1200 may represent, for example, computing or processing capabilities found within desktop, laptop and notebook computers, hand-held computing devices (personal digital assistants (PDAs), smart phones, cell phones, palmtops, etc.), mainframes, supercomputers, workstations or servers, or any other type of special-purpose computing devices as may be desirable or appropriate for a given application or environment. Computing component 1200 might also represent computing capabilities embedded within or otherwise available to a given device. For example, a computing component might be found in other electronic devices such as, for example, digital cameras, navigation systems, cellular telephones, portable computing devices, modems, routers, wireless application protocols (WAPs), terminals and other electronic devices that might include some form of processing capability.

Computing component 1200 might include, for example, one or more processors, controllers, control components, or other processing devices, such as a processor 1204. Processor 1204 might be implemented using a special-purpose processing engine such as, for example, a microprocessor, controller, or other control logic. In the illustrated example, processor 1204 is connected to a bus 1202, although any communication medium can be used to facilitate interaction with other components of computing component 1200 or to communicate externally.

Computing component 1200 might also include one or more memory components, simply referred to herein as main memory 1208. For example, random access memory (RAM) or other dynamic memory, might be used for storing information and instructions to be executed by processor 1204. Main memory 1208 might also be used for storing temporary variables or other intermediate information during execution of instructions to be executed by processor 1204. Computing component 1200 might likewise include a read only memory (ROM) or other static storage device coupled to bus 1202 for storing static information and instructions for processor 1204.

The computing component 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a floppy disk drive, a magnetic tape drive, an optical disk drive, a compact disc (CD) or digital versatile disc (DVD) drive (read-only or read/write), or other removable or fixed media drive might be provided. Accordingly, storage media 1214 might include, for example, a hard disk, a floppy disk, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing component 1200. Such instrumentalities might include, for example, a fixed or removable storage unit 1222 and a storage unit interface 1220. Examples of such storage units 1222 and storage unit interfaces 1220 can include a program cartridge and cartridge interface, a removable memory (for example, a flash memory or other removable memory component) and memory slot, a personal computer memory card international association (PCMCIA) slot and card, and other fixed or removable storage units 1222 and interfaces 1220 that allow software and data to be transferred from the storage unit 1222 to computing component 1200.

Computing component 1200 might also include a communications interface 1224. Communications interface 1224 might be used to allow software and data to be transferred between computing component 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1200 to perform features or functions of the disclosed technology as discussed herein.

### Appendix 1

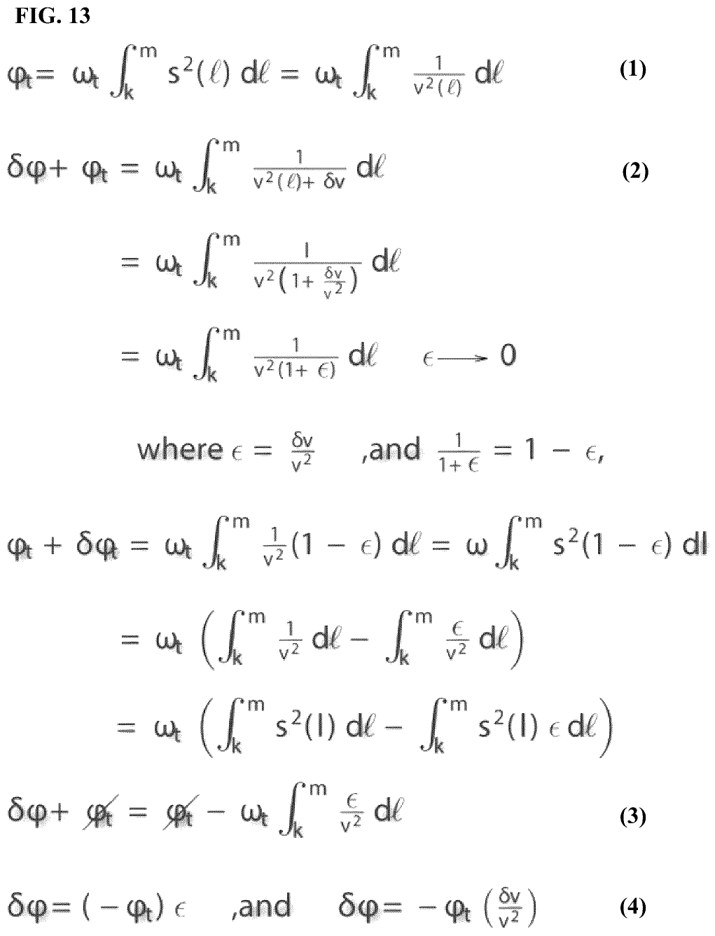

FIG. 13 depicts equations describing a wave formulation of phase differences according to this disclosure. These equations comprise a proof of the suitability of applying the phase estimates using wave theory.

The methodology described in this disclosure involves the validation of phase estimates using wave theory principles. The equations employ the concepts of Born's perturbation theory, which is instrumental in validating the fundamental assumption that differential phase measurements are precise indicators of variations within the examined propagation medium. Wave theory serves as a near-to-real theoretical framework that supports the expected results. Its confirmation of the same phenomena, as observed in practical applications, substantiates the use of infinitesimal theory in the calculations and simulations.

When wave theory corroborates the phenomena being measured, it strongly suggests that the infinitesimal approach, i.e., the assumption of rays being the only sensitive kernels for perturbations in the system, is accurate. This is because wave theory, aligning closely with real-world behaviors, provides a robust theoretical foundation that the infinitesimal methods must align with if they are to reflect true physical conditions.

By confirming the expected outcomes through wave theory, the infinitesimal theory (which is necessary for the applicable calculations and simulations of phase shifts and interference patterns) is shown to be not only theoretically sound but also practically viable. This confirmation bolsters confidence in the methodology's ability to provide reliable, high-fidelity measurements by ensuring that the mathematical models used are a true reflection of the underlying physical processes. Thus, the successful integration of wave theory into the methodology not only validates but also enhances the scientific rigor of the approach, providing a comprehensive and coherent framework that bridges theoretical physics with practical technological applications.

Equation 1 describes the unperturbed total phase, denoted Φₜ, which is quantified as the integral of slowness (s) across the ray path from point m to point l.

Equation 2 describes that perturbed phase signals, δΦ, are incorporated into the total phase Φ. These signals include the sum of perturbed slowness (s) along the ray path. The perturbation ratio ε=δv/v², is minimal, approaching zero, which signifies its negligible impact relative to the entire slowness field. Therefore, rearrangement leads to Equation 3.

Consequently, the relationship between δΦ and Φₜ is established as δΦ=−Φₜδv/v². Equation 4 emphasizes that the predicted kernel should represent a negative perturbation localized around (not on) the infinitesimal theoretical ray path.

### Appendix 2

Regarding solving equations for the disclosure, the double difference algorithm might be sensitive to errors in the absolute position of a cluster. Thus, equation (9) above is better to downweight during modelling to allow the cluster centroid to move slightly and correct for possible errors in the initial absolute spatial coordinates.

The matrix G is highly sparse as equation links two points, i.e., of the 4N columns in each of the M rows of G, only eight have nonzero elements. To enhance the numerical stability of the solution, G is scaled by normalizing the L2-norm of each column of G, i.e, |G×eᵢ|=1 for i=1 to N. If one point is poorly linked to all other points, then G is ill-conditioned, and the solution to equation (8) may become numerically unstable depending upon the solution method. In general, one way to regularize such ill-conditioned systems is by prefiltering the data by only including points that are well linked to other events. This may be achieved by only allowing point pairs which have more than a minimal number of observations. In general terms, this number however also depends on the geometrical distribution of the camera observing the two points.

One way of regularizing any moderately or severely ill-conditioned system is damping of the solution. Other constraints may be added, such as a smoothing function.

Such problems may be written as:

$$W [ \begin{matrix}G \\ ξ I\end{matrix} ] m = W [ \begin{matrix}d \\ 0\end{matrix} ] \qquad ( 11 )$$

with ξ being the damping factor that is important to regularize the modelling.

A standard approach to solving equation (8) in a weighted least-squares sense (i.e., minimizing the L2-norm of the residual vector) is the use of normal equations

$$\hat{m} = {( {G}^{T} {W}^{- 1} G )}^{- 1} {G}^{T} {W}^{- 1} d \qquad ( 12 )$$

with W containing a priori quality weights. The a priori weights express the normalized quality of that data; that is, the quality and consistency with which first-motion phase differences are determined on a routine basis (and maybe the relative accuracy between this data set and a reference correlation measurement).

For small clusters, and for well-conditioned systems, one can solve equation (8) by the method of singular value decomposition (SVD):

$$\hat{m} = ⋁ {⋀}^{- 1} {U}^{T} d \qquad ( 13 )$$

Where U and ∨ are two matrices of orthonormal singular vectors of the weighted matrix G, and ∧ is a diagonal matrix of the singular values of G. SVD may be used to investigate the behavior of small systems, as the matrices in equation (12) store information on the resolvability of the unknown parameters m and the amount of information (or lack thereof) supplied by the data d. Least squares estimates eᵢ are estimated for each model parameter i by

$${e}_{i}^{2} - {C}_{ij} \cdot var \qquad ( 14 )$$

where Cᵢⱼ are the diagonal elements of the covariance matrix

$$C = ⋁ {⋀}^{- 2} {⋁}^{T}$$

and the var is the variance of the weighted residuals calculated by

$$var = ( {\sum }_{i = 1}^{M} ( {( {d}_{i} - \overline{d} )}^{2} - ( \frac{{( {\sum }_{i = 1}^{M} ( {d}_{i} - \overline{d} ) )}^{2}}{M} ) ) / ( M - 4 N ) \qquad ( 15 )$$

Where d̅ is the mean of the residual vector and dᵢ is the residual of the i^{th} observation.

As the system to be solved becomes very large, SVD will become inefficient. In such cases the solution (m) may be found by using the conjugate gradient algorithm LSQR (Paige and Saunders, 1982) that takes advantage of the sparseness of the design matrix. LSQR solves the damped least-squares problem:

$${‖ W [ \begin{matrix}G \\ ξ I\end{matrix} ] m - W [ \begin{matrix}d \\ 0\end{matrix} ] ‖}_{2} = 0 \qquad ( 16 )$$

to find m.

Additional details:
Clause 1. An apparatus comprising: a first interferometer; a second interferometer; an illuminator that provides coherent light to the first interferometer and to the second interferometer; and an imager that simultaneously captures a first set of interferograms of a target object and a reference object from the first interferometer and a second set of interferograms of the target object and the reference object from the second interferometer, wherein the first set of interferograms and the second set of interferograms each encode phase information from the target object, the reference object, and noise sources, and wherein encoded noise data from the first set of interferograms and the second set of interferograms is differentially minimized to yield substantially noise-free phase information from the target object.
Clause 2. The apparatus of clause 1, wherein the first interferometer and the second interferometer are optically identical.
Clause 3. The apparatus of clause 1, wherein the first interferometer and the second interferometer share a common reference object.
Clause 4. The apparatus of clause 1, wherein the first interferometer and the second interferometer are positioned at substantially equal distances from the target object.
Clause 5. The apparatus of clause 1, wherein the first interferometer and the second interferometer are symmetrically positioned around the imager.
Clause 6. The apparatus of clause 1, wherein the coherent light comprises diffraction fringes.
Clause 7. The apparatus of clause 1, wherein the coherent light emitted by at least one of the first interferometer and the second interferometer passes through a compensator optical element.
Clause 8. The apparatus of clause 1, wherein the coherent light has a wavelength selected to provide a specific amount of intrinsic scattering within the target object.
Clause 9. The apparatus of clause 1, wherein the noise sources comprise at least one of thermal variations, air turbulence, micro-scatterers, external light sources, mechanical vibrations, and electromagnetic interference.
Clause 10. The apparatus of clause 1, wherein the target object comprises one of a region of dental anatomy and a geographic region.
Clause 11. A method, comprising: producing a first set of interferograms of a target object and a reference object using a first interferometer; simultaneously producing a second set of interferograms of the target object and the reference object using a second interferometer, wherein the first set of interferograms and the second set of interferograms each encode phase information from the target object, the reference object, and noise sources; and differentially minimizing encoded noise data from the first set of interferograms and from the second set of interferograms to yield substantially noise-free phase information from the target object.
Clause 12. The method of clause 11, wherein the first interferometer and the second interferometer are optically identical.
Clause 13. The method of clause 11, wherein the first interferometer and the second interferometer share a common reference object.
Clause 14. The method of clause 11, wherein the first interferometer and the second interferometer are positioned at substantially equal distances from the target object.
Clause 15. The method of clause 11, wherein the first interferometer and the second interferometer are symmetrically positioned around an imager that captures the first set of interferograms and the second set of interferograms.
Clause 16. The method of clause 11, wherein coherent light used by the first interferometer and the second interferometer comprises diffraction fringes.
Clause 17. The method of clause 11, wherein coherent light emitted by at least one of the first interferometer and the second interferometer passes through a compensator optical element.
Clause 18. The method of clause 11, wherein coherent light used by the first interferometer and the second interferometer has a wavelength selected to provide a specific amount of intrinsic scattering within the target object.
Clause 19. The method of clause 11, wherein the noise sources comprise at least one of thermal variations, air turbulence, micro-scatterers, external light sources, mechanical vibrations, and electromagnetic interference.
Clause 20. The method of clause 11, wherein the target object comprises one of a region of dental anatomy and a geographic region.
Clause 21. A system, comprising: means for producing a first set of interferograms of a target object and a reference object using a first interferometer; means for simultaneously producing a second set of interferograms of the target object and the reference object using a second interferometer, wherein the first set of interferograms and the second set of interferograms each encode phase information from the target object, the reference object, and noise sources; and means for differentially minimizing encoded noise data from the first set of interferograms and from the second set of interferograms to yield substantially noise-free phase information from the target object.
Clause 22. A computer program product comprising a non-transitory computer-readable medium with computer-executable instructions tangibly embodied thereon that, when executed by a processor, perform operations comprising: producing a first set of interferograms of a target object and a reference object using a first interferometer; simultaneously producing a second set of interferograms of the target object and the reference object using a second interferometer, wherein the first set of interferograms and the second set of interferograms each encode phase information from the target object, the reference object, and noise sources; and differentially minimizing encoded noise data from the first set of interferograms and from the second set of interferograms to yield substantially noise-free phase information from the target object.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any tune in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Having described the various embodiments, what is claimed is as follows.

The invention claimed is:

1. An apparatus comprising:
a first interferometer;
a second interferometer;
an illuminator that provides coherent light to the first interferometer and to the second interferometer; and
an imager that simultaneously captures a first set of interferograms of a target object and a reference object from the first interferometer and a second set of interferograms of the target object and the reference object from the second interferometer,
wherein the first set of interferograms and the second set of interferograms each encode phase information from the target object, the reference object, and noise sources, and
wherein encoded noise data from the first set of interferograms and the second set of interferograms is differentially minimized to yield substantially noise-free phase information from the target object.

2. The apparatus of claim 1, wherein the first interferometer and the second interferometer are optically identical.

3. The apparatus of claim 1, wherein the first interferometer and the second interferometer share a common reference object.

4. The apparatus of claim 1, wherein the first interferometer and the second interferometer are positioned at substantially equal distances from the target object.

5. The apparatus of claim 1, wherein the first interferometer and the second interferometer are symmetrically positioned around the imager.

6. The apparatus of claim 1, wherein the coherent light comprises diffraction fringes.

7. The apparatus of claim 1, wherein the coherent light emitted by at least one of the first interferometer and the second interferometer passes through a compensator optical element.

8. The apparatus of claim 1, wherein the coherent light has a wavelength selected to provide a specific amount of intrinsic scattering within the target object.

9. The apparatus of claim 1, wherein the noise sources comprise at least one of thermal variations, air turbulence, micro-scatterers, external light sources, mechanical vibrations, and electromagnetic interference.

10. The apparatus of claim 1, wherein the target object comprises one of a region of dental anatomy and a geographic region.

11. A method, comprising:
producing a first set of interferograms of a target object and a reference object using a first interferometer;
simultaneously producing a second set of interferograms of the target object and the reference object using a second interferometer,
wherein the first set of interferograms and the second set of interferograms each encode phase information from the target object, the reference object, and noise sources; and
differentially minimizing encoded noise data from the first set of interferograms and from the second set of interferograms to yield substantially noise-free phase information from the target object.

12. The method of claim 11, wherein the first interferometer and the second interferometer are optically identical.

13. The method of claim 11, wherein the first interferometer and the second interferometer share a common reference object.

14. The method of claim 11, wherein the first interferometer and the second interferometer are positioned at substantially equal distances from the target object.

15. The method of claim 11, wherein the first interferometer and the second interferometer are symmetrically positioned around an imager that captures the first set of interferograms and the second set of interferograms.

16. The method of claim 11, wherein coherent light used by the first interferometer and the second interferometer comprises diffraction fringes.

17. The method of claim 11, wherein coherent light emitted by at least one of the first interferometer and the second interferometer passes through a compensator optical element.

18. The method of claim 11, wherein coherent light used by the first interferometer and the second interferometer has a wavelength selected to provide a specific amount of intrinsic scattering within the target object.

19. The method of claim 11, wherein the noise sources comprise at least one of thermal variations, air turbulence, micro-scatterers, external light sources, mechanical vibrations, and electromagnetic interference.

20. The method of claim 11, wherein the target object comprises one of a region of dental anatomy and a geographic region.

21. A system, comprising:
means for producing a first set of interferograms of a target object and a reference object using a first interferometer;
means for simultaneously producing a second set of interferograms of the target object and the reference object using a second interferometer,
wherein the first set of interferograms and the second set of interferograms each encode phase information from the target object, the reference object, and noise sources; and
means for differentially minimizing encoded noise data from the first set of interferograms and from the second set of interferograms to yield substantially noise-free phase information from the target object.

22. A computer program product comprising a non-transitory computer-readable medium with computer-executable instructions tangibly embodied thereon that, when executed by a processor, perform operations comprising:
producing a first set of interferograms of a target object and a reference object using a first interferometer;
simultaneously producing a second set of interferograms of the target object and the reference object using a second interferometer,
wherein the first set of interferograms and the second set of interferograms each encode phase information from the target object, the reference object, and noise sources; and
differentially minimizing encoded noise data from the first set of interferograms and from the second set of interferograms to yield substantially noise-free phase information from the target object.
